(19) United States
(12) Patent Application Publication
(10) Pub. No.: US 2026/0111901 A1
(43) Pub. Date: Apr. 23, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Akira Yamaguchi, Kanagawa (JP); Katsuya Mitsutake, Kanagawa (JP)

(73) Assignee: FUJIFILM Business Innovation Corp., Tokyo (JP)

(21) Appl. No.: 19/205,456

(22) Filed: May 12, 2025

(30) Foreign Application Priority Data
Oct. 21, 2024 (JP) 2024-185201

(51) Int. Cl. G06Q 30/01; G06Q 10/02; H04L 65/1069; H04L 65/1089

(52) U.S. Cl. CPC G06Q 30/01; G06Q 10/02; H04L 65/1069; H04L 65/1089

(57) ABSTRACT

An information processing system includes a processor configured to, in a case where a provider provides a service to a booth in which plural providers that provide services are able to provide the services, from outside the booth via a network, implement an effect relating to the provider.

### CROSS-REFERENCE TO RELATED APPLICATIONS

This application is based on and claims priority under 35 USC 119 from Japanese Patent Application No. 2024-185201 filed Oct. 21, 2024.

### BACKGROUND

### (i) Technical Field

The present disclosure relates to an information processing system and a non-transitory computer readable medium.

### (ii) Related Art

In Japanese Unexamined Patent Application Publication No. 2023-16938, a lockable booth capable of ensuring efficiency of work performed by a user using a device carried with the user, is disclosed.

### SUMMARY

Aspects of non-limiting embodiments of the present disclosure relate to providing an information processing system capable of allowing, in a case where a provider of a service provides the service to a user of a booth from outside the booth via a network, the user to be able to feel a connection between the booth and the provider, compared to a configuration in which an effect irrelevant to the service provided from the provider to the user is implemented.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to, in a case where a provider provides a service to a booth in which a plurality of providers that provide services are able to provide the services, from outside the booth via a network, implement an effect relating to the provider.

### BRIEF DESCRIPTION OF THE DRAWINGS

Exemplary embodiments of the present disclosure will be described in detail based on the following figures, wherein:

FIG. 1 is a schematic diagram illustrating a hardware configuration of a booth system according to a first exemplary embodiment;

FIG. 2 is a schematic diagram illustrating the inside of a booth in the first exemplary embodiment and a usage state in which a user uses the booth;

FIG. 3 is a block diagram focusing on a controller in the first exemplary embodiment;

FIG. 4 is a sequence diagram illustrating how information is transferred during a period from reserving a booth to using the booth in the booth system according to the first exemplary embodiment in the case where the type of usage of a user of the booth is personal use;

FIG. 5 is a sequence diagram illustrating how information is transferred during a period from reserving a booth to using the booth in the booth system according to the first exemplary embodiment in the case where the type of usage of a user of the booth is business use;

FIG. 6A illustrates part of a reservation screen displayed on a terminal of a person who wishes to reserve a booth in the first exemplary embodiment, and the screen indicates the current reservation status;

FIG. 6B illustrates part of the reservation screen, and the screen indicates a state in which available slots are selected by the person who wishes to reserve the booth;

FIG. 6C illustrates part of the reservation screen indicating that the reservation for the available slots made by the person in FIG. 6B has been confirmed and displayed in the case where an option to disclose identity information has been selected in advance by the person;

FIG. 6D illustrates part of the reservation screen indicating that the reservation for the available slots made by the person in FIG. 6B has been completed and displayed when an option to not disclose identity information has been selected in advance by the person;

FIG. 7 is an entry procedure screen displayed on a terminal of a user of the booth in the first exemplary embodiment;

FIG. 8 is a flowchart illustrating a process to determine the type of usage of a user of the booth in the first exemplary embodiment;

FIG. 9 is a flowchart for a case where the type of usage of the user of the booth in the first exemplary embodiment is business use;

FIG. 10A is a schematic diagram illustrating a fixed terminal of a business operator and part of contents on a display screen of the fixed terminal in the case where the user of the booth in the first exemplary embodiment has gone through an entry procedure;

FIG. 10B is a schematic diagram illustrating a portable terminal of a business operator and part of contents on a display screen of the portable terminal in the case where the user of the booth has gone through the entry procedure;

FIG. 11A illustrates a monitor of the booth in the first exemplary embodiment that displays a logo of A Bank that provides a service;

FIG. 11B illustrates the monitor of the booth that displays a message, along with the contents in FIG. 11A;

FIG. 11C illustrates the monitor of the booth that displays a screen on which the name of a customer, along with the contents in FIG. 11B, is displayed;

FIG. 12A is a schematic diagram illustrating a display screen of a fixed terminal of a business operator presented when the business operator is providing a service to a customer as the user of the booth in the first exemplary embodiment, the display screen being presented immediately after provision of the service starts;

FIG. 12B is a schematic diagram illustrating the display screen presented ten minutes before the end of provision of the service;

FIG. 12C is a schematic diagram illustrating the display screen presented when provision of the service ends;

FIG. 13A is a schematic diagram illustrating a display screen of the monitor of the booth in the first exemplary embodiment presented immediately after provision of the service starts;

FIG. 13B is a schematic diagram illustrating the display screen presented ten minutes before the end of provision of the service; and

FIG. 13C is a schematic diagram illustrating the display screen presented when provision of the service ends.

### DETAILED DESCRIPTION

Hereinafter, exemplary embodiments of the present disclosure will be described with reference to drawings. In the drawings, the same or equivalent component elements and parts are denoted by the same reference signs.

### Configuration of Exemplary Embodiment

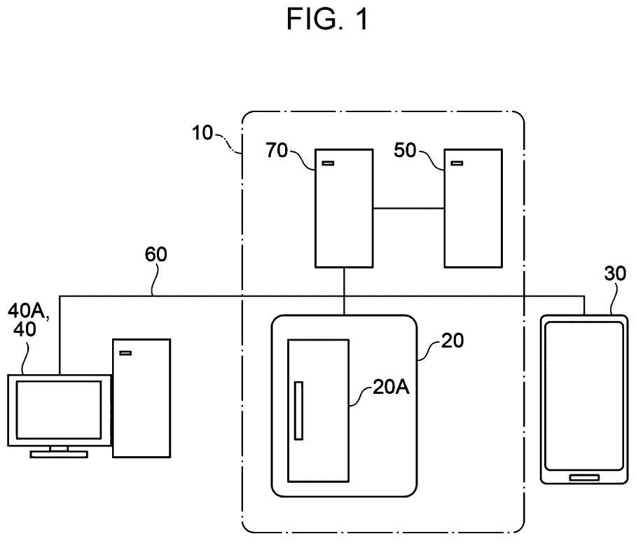

A booth system 10 according to an exemplary embodiment will be described. As illustrated in FIG. 1, the booth system 10 includes a booth 20, a reservation database 50, and a controller 70. The booth system 10 is a system that allows a user U to reserve the booth 20 via an internet line 60 so that the user U is able to use the booth 20. The internet line 60 is an example of a network. The booth system 10 is connected to a user terminal 30 and a business operator terminal 40, which will be described later, via the internet line 60. Although the booth system 10 includes a plurality of booths 20, only one booth is illustrated in FIG. 1. Hereinafter, a specific booth 20 out of the plurality of booths 20 will be described, unless otherwise stated. Furthermore, it is assumed that the booth system 10 is managed by someone different from a business operator B, who will be described later.

The booth system 10 is capable of provision to a system user S of the booth system 10 both in the case where the type of usage of the user U of the booth 20 is personal use and the case where the type of usage of the user U of the booth 20 is business use.

Personal use represents usage of the booth 20 for the purpose of remote work, study, or the like by an individual user I as the user U. In the case of personal use, the individual user I serves as both the system user S of the booth system 10 and the user U of the booth 20.

In the case of business use, the business operator B provides, from outside the booth 20 via the internet line 60, a service to a customer C of the business operator B who is inside the booth 20. The business operator B is an example of a provider of a service. In the case of business use, the business operator B or a person in charge P, who will be described later, serves as the system user S of the booth system 10. Furthermore, in the case of business use, the customer C serves as the user U of the booth 20. That is, in the case of business use, the system user S of the booth system 10 and the user U of the booth 20 are not the same.

### Booth

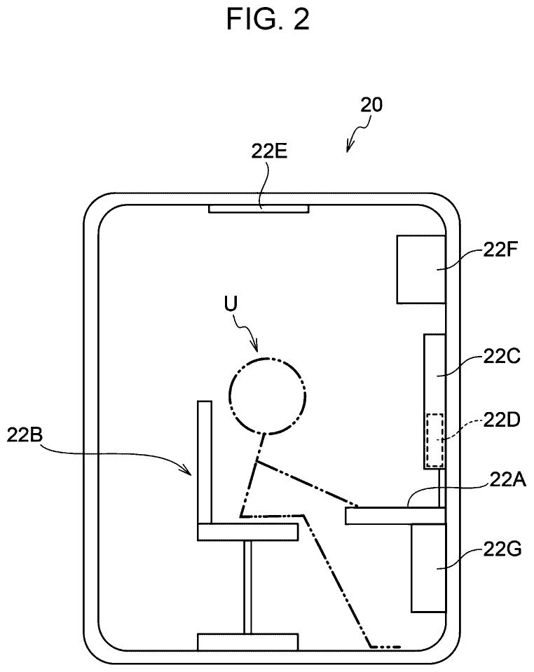

The booth 20 is a partitioned section or a small room and is, preferably, a private room that one or a plurality of users with the same purpose of use are able to use. In this exemplary embodiment, the booth 20 is, as illustrated in FIGS. 1 and 2, a box that is surrounded on at least four sides. Furthermore, in this exemplary embodiment, the booth 20 is installed in a building (not illustrated in drawings). The building may be a station (station premises), a hotel, a karaoke room facility, or any other facilities where the user U comes and goes. Alternatively, the building may be a room in the station, the hotel, the karaoke room facility, or any other facilities. The booth 20 has a door 20A. By opening and closing the door 20A, the door 20A allows the user U to pass through to enter and leave the booth 20. In an environment where, for example, sound outside the booth 20 is blocked and public attention is avoided, booth devices 22 installed at the booth 20 may be used by the user U depending on the type of use.

It is assumed that, in the case of business use, there are a plurality of business operators B who have completed the initial setup (business operators B who have done registration for use), which is to be done before using the booth system 10. In the booth 20, one of the business operators B who have completed the registration for use is able to provide a service corresponding to the business operator B within a reserved slot.

The booth 20 includes a locking device (not illustrated in drawings) and booth devices 22. The locking device is a device that is arranged inside the booth 20 and locks the door 20A all the time. The locking device locks or unlocks the door 20A, based on key information, which will be described later, in accordance with an instruction from a booth controller 22G. The locking device may directly lock or unlock the door 20A in accordance with an instruction from the controller 70.

As the booth devices 22, a desk 22A, a chair 22B, and a monitor 22C are provided at the booth 20. Furthermore, as the booth devices 22, a speaker 22D, a light 22E, an air-conditioning device 22F, and the booth controller 22G are provided at the booth 20.

The monitor 22C is a device that is installed at the desk 22A or on the inner wall of the booth 20 and displays an image on the screen thereof for the user U. The monitor 22C is an example of a display device. Furthermore, being installed is an example of being provided. In this exemplary embodiment, the monitor 22C is installed on the inner wall of the booth 20 above the desk 22A.

The monitor 22C may include a projector that is installed inside the booth 20 and displays, for the user U of the booth 20, an image onto the inner wall of the booth 20 or a screen. Furthermore, a plurality of display devices may be combined together.

The speaker 22D is a device that is installed inside the booth 20 and transmits audio information to the user U of the booth 20. The audio information represents information that provides auditory stimulation to the user U, such as sound, music, and the like. The speaker 22D is an example of an audio device. The audio information is an example of sound. In this exemplary embodiment, the speaker 22D is installed inside the monitor 22C and is integrated with the monitor 22C.

The speaker 22D may be attached to the desk 22A or the inner wall. Furthermore, a plurality of audio devices may be combined together.

The light 22E is a device that is installed inside the booth 20 and illuminates the inside of the booth 20. The light 22E is an example of a lighting device. In this exemplary embodiment, the light 22E is attached to the ceiling of the booth 20. Brightness and color of the light 22E may be changed by the controller 70, which will be described later.

The light 22E may include a spot light installed on the inner wall of the booth 20 or at a place near the feet of the user, a desk light installed at the desk 22A, and a projector illuminating the inner wall of the booth 20 or a screen. A plurality of lighting devices may be combined together. Furthermore, the light 22E may be provided outside the booth 20.

The air-conditioning device 22F is a device that adjusts the air inside the booth 20 on the basis of predetermined air-conditioning conditions (temperature, humidity, wind direction, and air volume). In this exemplary embodiment, an indoor unit of the air-conditioning device 22F is installed on the inner wall of the booth 20 above the monitor 22C. Furthermore, an outdoor unit of the air-conditioning device 22F is installed outside the booth 20, for example, at a roof part (not illustrated in drawings).

The booth controller 22G is installed at the booth 20 so as to control the booth devices 22.

### Reservation Database

The reservation database 50 records reservation information on each booth 20 and sends and receives information in response to a request from the controller 70. Hereinafter, in this exemplary embodiment, the reservation database 50 will be referred to as a reservation DB 50. Reservation information contains the location of a booth 20 reserved by the system user S, identification information for distinguishing the reserved booth 20 from other booths 20, and the date and time for which the reservation is made. Furthermore, the reservation information contains a user ID, key information for unlocking the locking device (not illustrated in drawings) at the door 20A of the booth 20, a payment method for the booth 20, and a reservation cancelation method. In the case where the type of usage of the user U is business use, the reservation information contains business operator information on the business operator B, effect information, which will be described later, and evaluation information on each person in charge P for the case where a plurality of persons in charge P are in the business operator B.

The reservation DB 50 may be integrated with the controller 70. Furthermore, the reservation DB 50 may send or receive information directly to and from the user terminal 30 and the business operator terminal 40 without going through the controller 70.

### Controller

The controller 70 as a managing server manages each booth 20. The controller 70 is connected to the booth controller 22G of each booth 20 via the internet line 60.

The controller 70 controls the booth controller 22G, based on the type of usage of the user U of each booth 20 and reservation information in the reservation DB 50.

In the case where the type of usage of the user U of the booth 20 is personal use, the controller 70 controls the user terminal 30, the reservation DB 50, and the booth devices 22 of the booth 20.

In the case where the type of usage of the user U of the booth 20 is business use, the controller 70 controls the user terminal 30, the business operator terminal 40, the reservation DB 50, and the booth devices 22 of the booth 20. In this case, the controller 70 does not allow the user terminal 30 of the customer C to control the booth devices 22. Alternatively, in this case, the controller 70 restricts control of the booth devices 22 by the user terminal 30 of the customer C, compared to the case where the type of usage is personal use. Specific control will be described later.

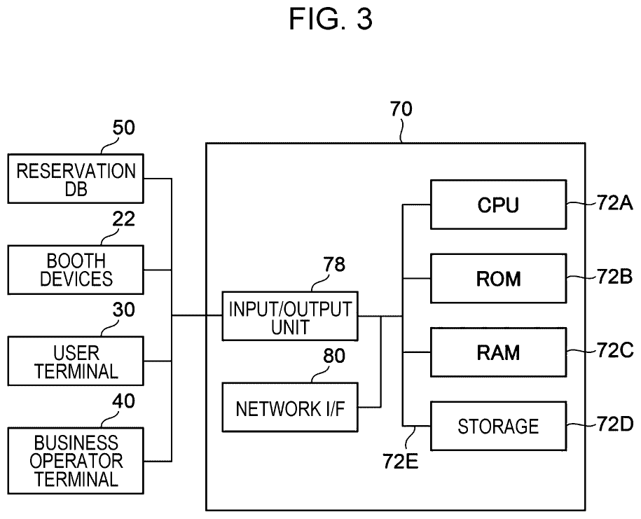

As illustrated in FIG. 3, the controller 70 includes a central processing unit (CPU) 72A, a read only memory (ROM) 72B, a random access memory (RAM) 72C, a storage 72D, an input/output unit 78, and a network interface (network I/F) 80. The units mentioned above are connected to one another by a bus 72E so that they are able to communicate with one another. The controller 70 is an example of an information processing system.

The CPU 72A is a central processing unit that executes various programs and controls various units. That is, the CPU 72A reads a program from the ROM 72B or the storage 72D and executes the program by using the RAM 72C as an operation area. The CPU 72A is an example of a processor, and a control program executed by the CPU 72A is an example of an information processing program. The CPU 72A performs control of the units mentioned above and various arithmetic processes on the basis of the program recorded in the ROM 72B or the storage 72D.

The ROM 72B stores various programs and various data. The RAM 72C, as an operation area, temporarily stores a program or data. The storage 72D includes a hard disk drive (HDD) or a solid state drive (SSD) and stores various programs including an operating system and various data.

The input/output unit 78 receives signals between component elements of the booth system 10 so that functions of the booth system 10 will be carried out.

The network I/F 80 is an interface for implementing communication with a database or other apparatuses such as a server, which are not illustrated in drawings. For example, standards such as Ethernet (registered trademark), fiber distributed data interface (FDDI), or Wi-Fi (registered trademark) are used for the network I/F 80.

Next, the user terminal 30 and the business operator terminal 40, which externally connect to the booth system 10, will be described.

### User Terminal

As illustrated in FIG. 1, the user terminal 30 is a terminal owned by the user U who uses the booth 20. The user terminal 30 is capable of connecting to component elements of the booth system 10 via the internet line 60. The user terminal 30 is a mobile phone, for example, a smartphone. The user terminal 30 is used to reserve the booth 20, carry out an entry procedure, connect to the monitor 22C in the case of personal use, and so on.

The user terminal 30 is not necessarily a mobile phone as long as it has a display screen. For example, the user terminal 30 may be a personal computer, a tablet, or the like.

### Business Operator Terminal

The business operator terminal 40 is a terminal that is owned by a business operator who provides to the customer C a service from outside the booth 20 via the internet line 60. The business operator terminal 40 is a personal computer. The business operator terminal 40 is installed at a base of the business operator B or a base of the person in charge P of the business operator B, for example, installed at home. The person in charge P is a person who is in charge of providing a service of the business operator B to the customer C.

The business operator terminal 40 is not necessarily a personal computer as long as it has a display screen. For example, the business operator terminal 40 may be a mobile phone, for example, a smartphone, a tablet, a dedicated terminal, or the like.

### Sequence From Making a Reservation to Using a Booth

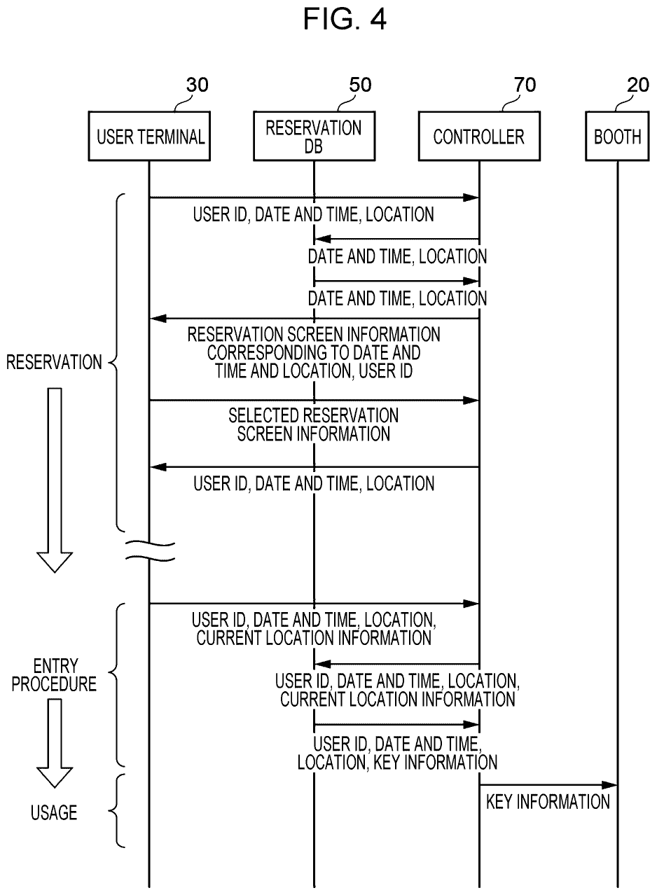

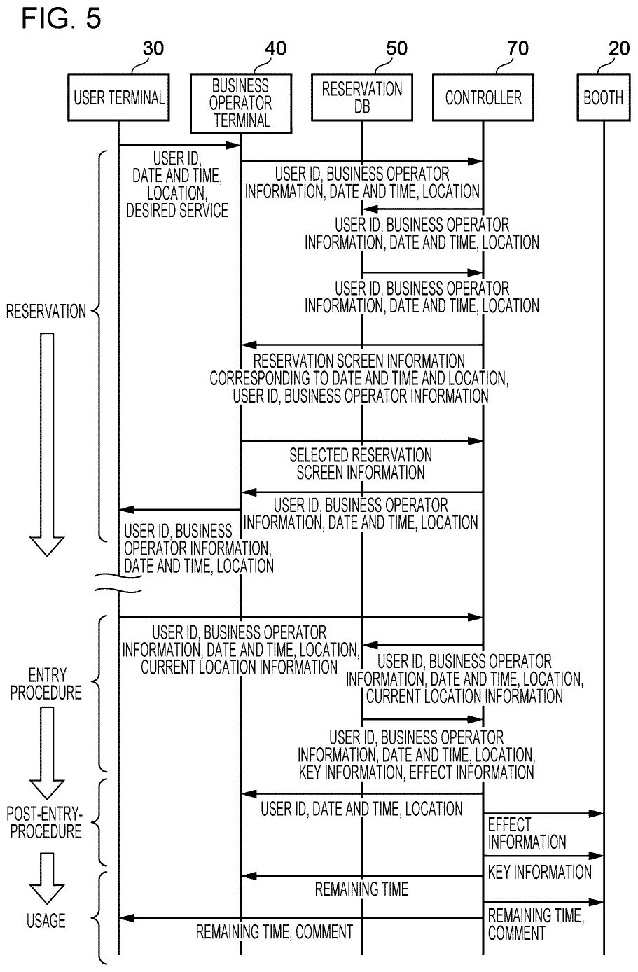

Next, a concept of how information is transferred during a period from reserving the booth 20 to using the booth 20 in the booth system 10 will be explained. As illustrated in FIGS. 4 and 5, information is transferred among elements in the booth system 10 during a period from reserving a booth to using the booth.

### Type of Usage 1: Personal Use

As illustrated in FIG. 4, in the case where the type of usage of the user U of the booth 20 is personal use, information is transferred among the user terminal 30, the reservation DB 50, the controller 70, and the booth 20. Hereinafter, for convenience of explanation, the purpose of transfer of information may be mentioned. However, purposes of transfer of information are not limited to the purposes mentioned below.

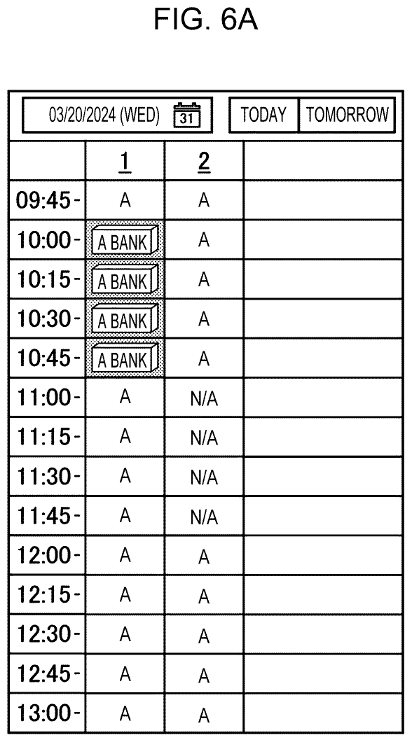

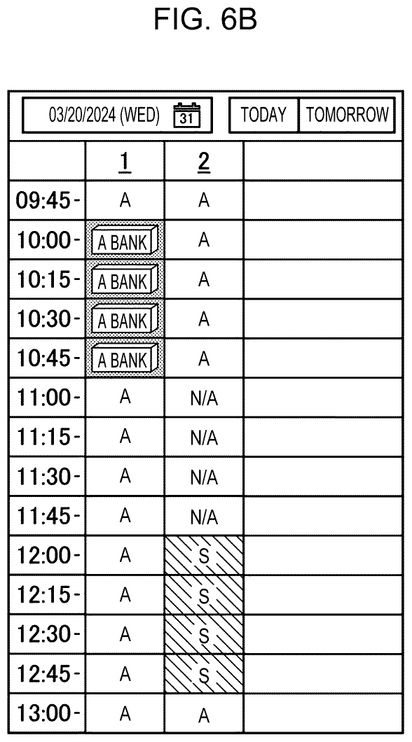

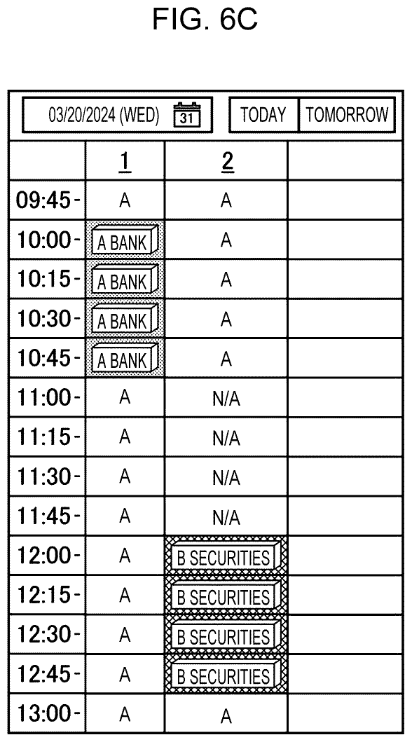

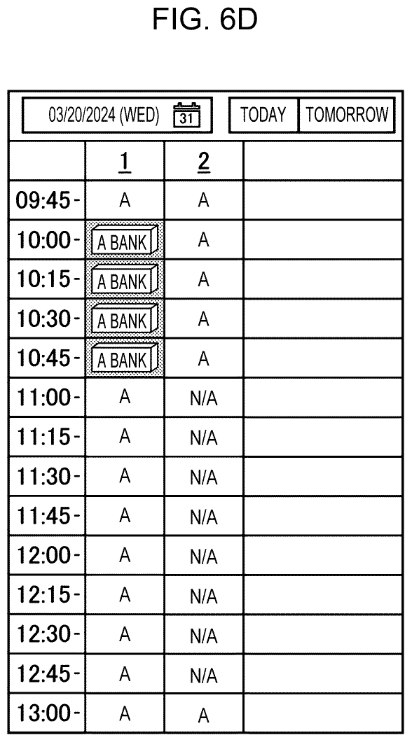

First, transfer of information at a reservation stage will be explained. At the reservation stage, to make a reservation, reservation information containing a user ID, date and time, and location is transmitted from the user terminal 30 to the controller 70. Next, for verification of a reservation status, reservation information containing the date and time and the location is transmitted from the controller 70 to the reservation DB 50. Next, as a verification result, reservation information containing the date and time and the location is transmitted from the reservation DB 50 to the controller 70. Next, reservation screen information (see FIG. 6A) corresponding to the date and time and the location and the user ID are transmitted from the controller 70 to the user terminal 30. Next, reservation screen information in which the date and time and the location are selected from available slots, which will be described later, in the reservation screen information is transmitted from the user terminal 30 to the controller 70. Then, for confirmation of the reservation, reservation information containing the user ID, the date and time, and the location is transmitted from the controller 70 to the user terminal 30. The information for the reservation stage is transferred as described above.

Next, transfer of information at an entry procedure stage will be explained. The entry procedure represents expression of the intention of entry by the user terminal 30. Examples of the entry procedure include a state in which the current location of the user terminal 30 is within a predetermined range from the reserved booth 20 and an unlock button, which will be described later, of the user terminal 30 is pressed.

At the entry procedure stage, reservation information containing the user ID of the individual user I, the date and time, the location, and current location information of the user terminal 30 of the individual user I is transmitted from the user terminal 30 of the individual user I to the controller 70. Next, for verification of the reservation status, the user ID, the date and time, the location, and the current location information of the user terminal 30 are transmitted from the controller 70 to the reservation DB 50. Then, as a verification result of the reservation status, reservation information containing the user ID, the date and time, the location, and key information is transmitted from the reservation DB 50 to the controller 70. The information for the entry procedure stage is transferred as described above.

Lastly, transfer of information at a usage stage of the booth 20 will be explained. At the usage stage of the booth 20, the key information (including information indicating that the type of use is personal use) is transmitted from the controller 70 to the booth 20. The key information allows the door 20A of the booth 20 to be unlocked. As a result, the user U is able to use the booth 20.

### Type of Usage 2: Business Use

As illustrated in FIG. 5, in the case where the type of usage of the user U of the booth 20 is business use, information is transferred among the user terminal 30, the business operator terminal 40, the reservation DB 50, the controller 70, and the booth 20.

First, transfer of information at the reservation stage will be explained. At the reservation stage, for application for provision of a service, reservation information regarding a user ID, date and time, location, and the service that is requested to be provided by the business operator B is transmitted from the user terminal 30 of the customer C to the business operator terminal 40 of the business operator B in a desired manner. Next, to reserve the booth 20, reservation information containing the user ID, business operator information, the date and time, and the location is transmitted from the business operator terminal 40 to the controller 70. Next, for verification of the reservation status, reservation information containing the user ID, the business operator information, the date and time, and the location is transmitted from the controller 70 to the reservation DB 50. Next, as a verification result, reservation information containing the user ID, the business operator information, the date and time, and the location is transmitted from the reservation DB 50 to the controller 70. Next, reservation screen information (see FIG. 6A) corresponding to the date and time and the location, the user ID, and the business operator information are transmitted from the controller 70 to the business operator terminal 40. Next, reservation screen information in which the date and time and the location are selected from available slots, which will be described later, by the business operator B in the reservation screen information is transmitted from the business operator terminal 40 to the controller 70. Furthermore, for confirmation of the reservation of the booth 20, reservation information containing the user ID, the business operator information, the date and time, and the location is transmitted from the controller 70 to the business operator terminal 40. Then, for application for provision of the service, the reservation information containing the user ID, the business operator information, the date and time, and the location is transmitted from the business operator terminal 40 to the user terminal 30 of the customer C in a desired manner. The information for the reservation stage is transferred as described above.

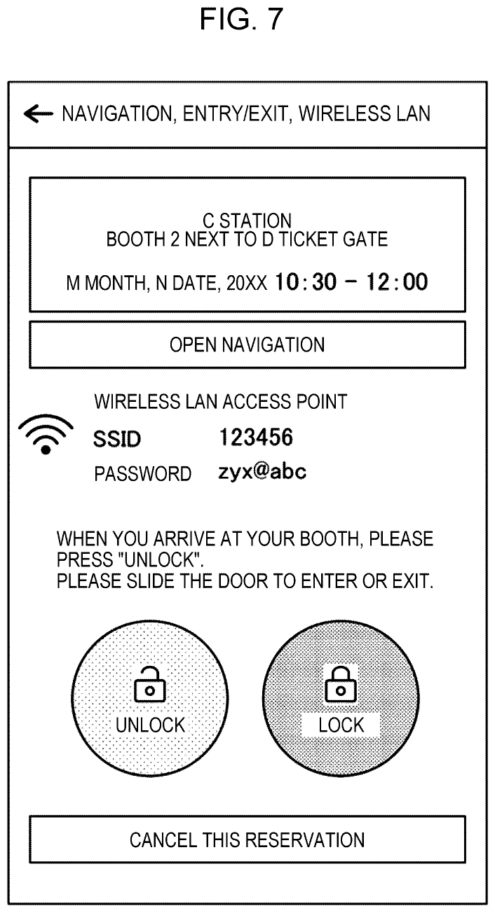

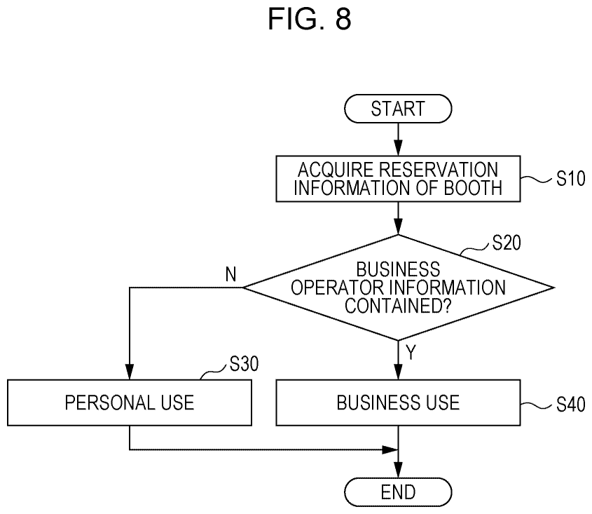

Next, transfer of information at the entry procedure stage will be explained. At the entry procedure stage, for the entry procedure, reservation information containing the user ID, the business operator information, the date and time, the location, and current location information of the user terminal 30 of the customer C is transmitted, through an entry procedure screen (see FIG. 7), from the user terminal 30 of the customer C to the controller 70. Next, for verification of the reservation status, the user ID, the business operator information, the date and time, the location, and the current location information of the user terminal 30 of the customer C are transmitted from the controller 70 to the reservation DB 50. Then, as a verification result of the reservation status, reservation information containing the user ID, the business operator information, the date and time, the location, key information, and effect information is transmitted from the reservation DB 50 to the controller 70. The information for the entry procedure stage is transferred as described above.

Next, transfer of information at a post-entry-procedure stage will be explained. The post-entry-procedure represents a stage subsequent to the entry procedure stage. The post-entry-procedure stage is a stage unique to the case where the type of usage of the user U is business use.

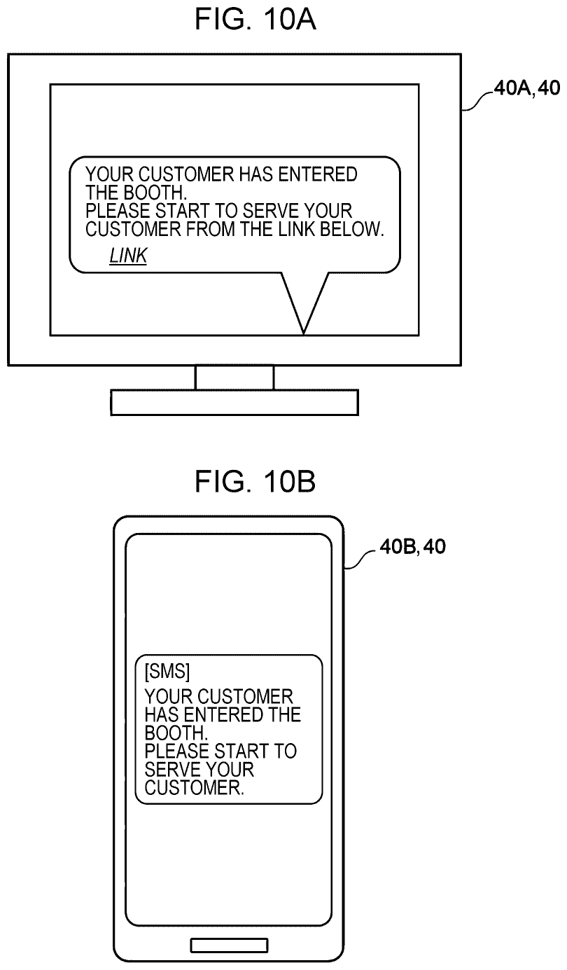

At the post-entry-procedure stage, for notification to the business operator B, reservation information containing the user ID, the date and time, and the location is transmitted from the controller 70 to the business operator terminal 40 (see FIG. 10). Furthermore, at the post-entry-procedure stage, the effect information is transmitted from the controller 70 to the booth 20. The information for the post-entry-procedure stage is transferred as described above.

Lastly, transfer of information at the usage stage of the booth 20 will be explained. At the usage stage of the booth 20, the key information is transmitted from the controller 70 to the booth 20. When an unlocking instruction is issued, for progress management, information containing the remaining time is transmitted from the controller 70 to the business operator terminal 40. Furthermore, for progress management, the remaining time and a comment containing information helpful to the customer C are transmitted to the booth 20 (monitor 22C) and the user terminal 30. The information for the usage stage is transferred as described above.

At the reservation stage for the booth 20, in the case where the type of usage of the user U is business use, information may be transferred as described below, taking into consideration the burden of the business operator B to make a reservation among the booth 20, the user U, and the business operator B. It is assumed that calendar information for each business operator B and each person in charge P for the business operator B is registered in advance in the reservation DB 50. Furthermore, it is assumed that application to the business operator B for provision of a service is directly made to the booth system 10 by the customer C.

For example, by being triggered by making a reservation by the customer C, possible reservation screen information may be transmitted from the controller 70 to the user terminal 30 of the customer C, based on the calendar information of the business operator B and the person in charge P and the availability of the booth 20. Furthermore, for selection of a person in charge P, evaluation information on each person in charge P, a face image of each person in charge P, self-introduction text by each person in charge P, and the like may be transmitted as possible reservation screen information.

### Configuration of Screens

Next, configuration of screens in the booth system 10 will be described. The screens include a reservation screen, an entry procedure screen, a post-entry-procedure screen, and an in-use screen.

### Reservation Screen

The reservation screen displayed on the user terminal 30 or the business operator terminal 40 will be explained. The reservation screen, as a specific aspect of the reservation screen information in FIG. 4 or 5, is displayed on the user terminal 30 or the business operator terminal 40, in response to a request from the controller 70. In FIGS. 6A to 6D, reservation screens indicating two booths 20 that match a time period and an area desired by the system user S are illustrated.

On the reservation screen, as illustrated in FIG. 6A, “A” indicating an available slot in which the booth 20 is available to use and “N/A” indicating an unavailable slot in which the booth 20 is not available to use are displayed for individual time slots. Furthermore, on the reservation screen, a logo of the business operator B (A Bank), which is a display aspect of an unavailable slot, is displayed in a color, for example, a corporate color. The color may be a color associated with the business operator B. The color may be a background color or a font color.

As illustrated in FIG. 6B, when part of available slots is selected by the system user S, the corresponding part is indicated as being selected “S” on the reservation screen.

Furthermore, as illustrated in FIG. 6C, when the reservation of the slots indicated as being selected “S” is confirmed in the case where the person who wishes to make a reservation is a business operator B who has agreed to disclose identity information, a logo of the business operator B (B Securities) is displayed in a corresponding color on the reservation screen that may be viewed by a third party. On the reservation screen that may be viewed by a third party, only the logo of the business operator B or a color corresponding to the business operator B, for example, the corporate color, may be displayed.

In contrast, as illustrated in FIG. 6D, when the reservation of the slots indicated as being selected “S” is confirmed in the case where the person who wishes to make a reservation corresponds to one of the cases described below, “N/A” indicating an unavailable slot is displayed on the reservation screen that may be viewed by a third party. The cases include a case where the person who wishes to make a reservation is an individual user I, a case where the person who wishes to make a reservation is a business operator B who does not agree to disclose identity information, a case where the person who wishes to make a reservation is a business operator B who requests non-disclosure in a uniform manner depending on a service, and the like. That is, unavailable slots are displayed in different manners depending on the type of usage, selection by the business operator B as the person who wishes to make a reservation, and the nature of a service provided by the business operator B.

At the initial setup before the use of the booth system 10 or every time that a reservation is made, the business operator B is able to select whether or not to disclose identity information.

The reservation screen is configured as described above.

### Entry Procedure Screen

Next, the entry procedure screen for entry to the booth 20 will be explained. As a specific aspect of information for the entry procedure stage in FIGS. 4 and 5, the entry procedure screen is displayed on the user terminal 30, based on any of triggers described below.

As an example of a trigger, based on a scheduled usage time, an electronic mail or a notification of a dedicated application including a link to the entry procedure screen is transmitted to the user terminal 30 (not illustrated in drawings). Furthermore, as another example of a trigger, the electronic mail or the notification may be transmitted based on the current location information of the user terminal 30, in addition to the scheduled usage time.

In FIG. 7, for convenience of explanation, a screen for entry procedure for a specific date, a specific time period, and a specific booth 20 is illustrated. Furthermore, for the entry procedure, a common screen is used regardless of the type of usage. Contents on the screen may be different depending on the type of usage.

On the entry procedure screen, a character string “C Station, Booth 2 next to D Ticket Gate” on M Month, N Date, 20XX at 10:30 to 12:00, which is reservation information, a plurality of buttons, and guidance text to the user U are included.

On the entry procedure screen, an unlock button, a lock button, and a cancel button are included as the plurality of buttons. The unlock button has a function for, when the unlock button is pressed, allowing the user U to unlock a key of the booth 20 before entry to the booth 20 and a function for, when the unlock button is pressed, allowing the user U to unlock the key of the booth 20 that has been locked after entry to the booth 20. The lock button has a function for, when the lock button is pressed, allowing the user U to lock the key of the booth 20 after entry to the booth 20. The cancel button has a function for, when the cancel button is pressed, allowing the user U to cancel the use of the booth 20 before entry to the booth 20.

The reservation information contains a map around the booth 20 to be used by the user U.

The entry procedure screen is configured as described above.

### Post-Entry-Procedure Screen

Next, a post-entry-procedure screen displayed after the entry procedure is carried out will be explained. The post-entry-procedure screen is displayed on the business operator terminal 40.

On the post-entry-procedure screen, for example, as illustrated in FIG. 10A, a message indicating that the customer C has entered the booth 20 and a link to provide a service to the customer C are displayed on a fixed terminal 40A, which is an example of the business operator terminal 40 of the business operator B (including the person in charge P of the business operator B).

Furthermore, on the post-entry-procedure screen, for example, as illustrated in FIG. 10B, a message indicating that the customer C has entered the booth 20 is displayed to a portable terminal 40B owned by the person in charge P of the business operator B.

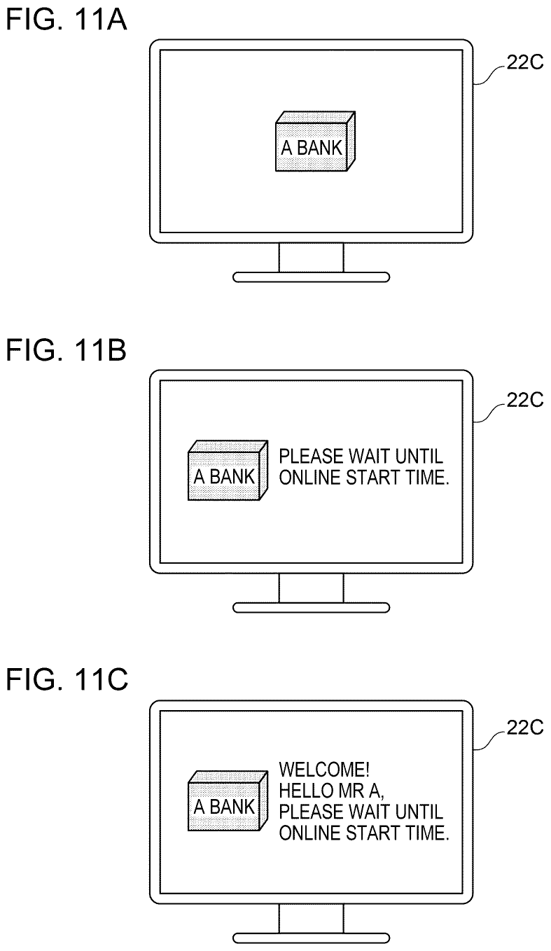

Furthermore, on the post-entry-procedure screen, for example, as illustrated in FIGS. 11A to 11C, effect information for allowing the customer C to identify the booth 20 as the expected booth 20 for the business operator B is displayed to the monitor 22C of the booth 20.

For example, as the post-entry-procedure screen, as illustrated in FIG. 11A, information such as the logo of the business operator B who is supposed to provide the service to the customer C or the color that is associated with the business operator B (for example, the corporate color) is displayed on the screen.

As another example, in addition to the information in FIG. 11A, information such as a message relating to the current status (for example, waiting until the start of the scheduled usage time) may also be displayed on the screen as the post-entry-procedure screen, as illustrated in FIG. 11B.

Furthermore, as another example, in addition to the information in FIG. 11B, information such as the name or nickname of the customer C may also be displayed on the screen as the post-entry-procedure screen, as illustrated in FIG. 11C.

The post-entry-procedure screen is configured as described above.

### In-Use Screen

Next, an in-use screen displayed in the case where the booth 20 is being used by the user U will be explained. The in-use screen is a screen displayed on the monitor 22C of the booth 20 or the business operator terminal 40 at the usage stage illustrated in FIG. 5. Contents on the in-use screen and a device on which the in-use screen is displayed are different depending on the type of usage.

In the case where the type of usage of the user U of the booth 20 is personal use, the controller 70 or the booth controller 22G may cause the monitor 22C of the booth 20 to display, as the in-use screen, a screen indicating that the individual user I is able to use the monitor 22C. In this case, the user terminal 30 of the individual user I may be used as a sub-screen. The controller 70 or the booth controller 22G may cause the user terminal 30 to display to the user terminal 30 information (or a guide) indicating that the individual user I is able to use the monitor 22C.

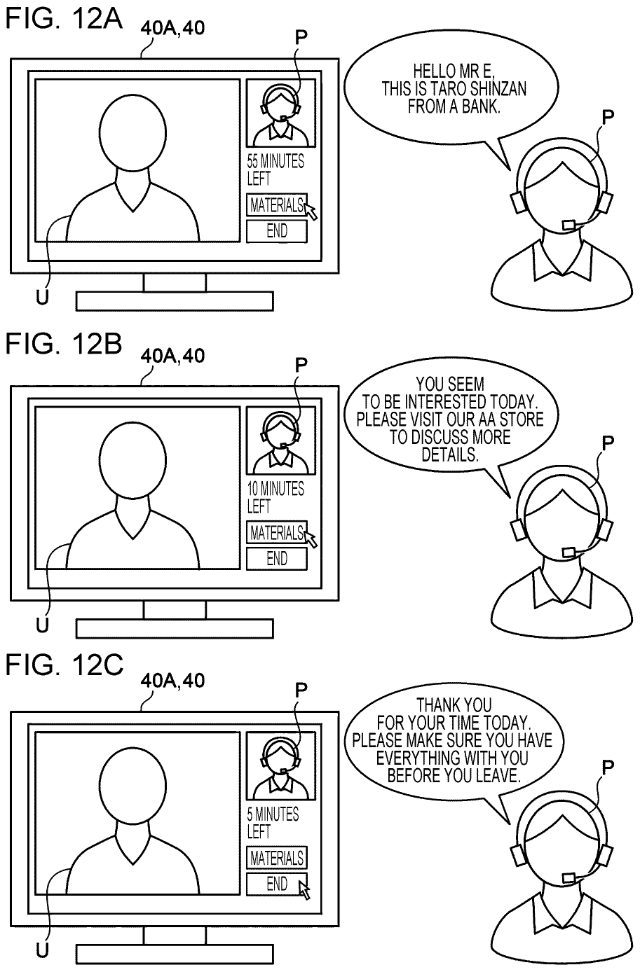

On the in-use screen, for example, as illustrated in FIG. 12A, information described below is displayed to the fixed terminal 40A. On the in-use screen, information including a real-time video containing the face of the customer C, a real-time video containing the face of the person in charge P of the business operator B, and the remaining time until the scheduled usage end time for progress management is displayed. Furthermore, on the in-use screen, information containing a materials display button for displaying materials relating to the service being provided to the customer C and an end button for ending provision of the service is displayed. The remaining time until the scheduled usage end time is an example of information based on the scheduled usage time. On the in-use screen, a comment encouraging the person in charge P to carry out progress management may be included as the information based on the scheduled usage time.

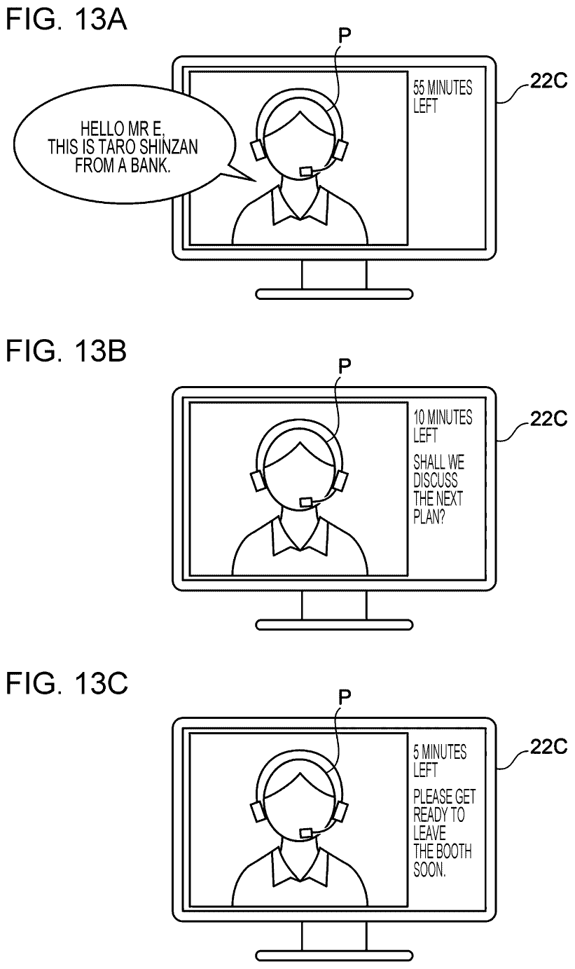

Furthermore, on the in-use screen, information for allowing the customer C to identify the business operator B is displayed to the monitor 22C of the booth 20. This information may be displayed on the user terminal 30 of the customer C. For example, as illustrated in FIGS. 13A to 13C, information described below is displayed as the in-use screen on the monitor 22C of the booth 20. On the in-use screen, a real-time video containing the face of the person in charge P who is providing the service to the customer C, the remaining time, a comment regarding the remaining time that is helpful to the customer C, and the like are displayed. The real-time video containing the face of the person in charge P is an example of information on the person in charge. Information displayed on the in-use screen may include information indicating that the user U is not able to use the monitor 22C. On the in-use screen, information indicating whether or not the user U is able to use the monitor 22C is not necessarily displayed. Furthermore, the in-use screen may include a sub-screen. Contents on the sub-screen may be set in a desired manner by the business operator B.

The in-use screen is configured as described above. Furthermore, the screens in the booth system 10 are configured as described above.

### Configuration of Effects

Next, effects implemented by the booth devices 22 of the booth 20 will be explained.

An effect represents causing a booth device 22 to implement a function of the booth device 22, in association with provision of a service to the customer C by the business operator B. An effect is implemented in the case where the type of usage is business use.

Furthermore, effect information, which is an item of reservation information, is information on a specific effect that the business operator B causes a booth device 22 of the booth 20 to implement for the customer C. The effect information contains, for example, information indicating whether or not an effect is necessary, the details of the effect, a method for providing the effect, and a time during which the effect is implemented (start time and end time).

The details of the effect contain a specific booth device 22 that is to implement the effect and contents of the effect to be implemented. The contents contain an effect relating to the business operator B itself and an effect relating to the service of the business operator B.

The method for providing the effect is not limited to a particular method as long as it appeals in a visual, olfactory, haptic, auditory, or other ways to the customer C who uses the booth 20. Furthermore, an effect is not necessarily implemented in one method but in a way in which a plurality of methods are combined.

For example, in the case where the business operator B is a bank and the service of the business operator B is offering a loan or selling or dealing with inquiries about a financial product, displaying a logo of the business operator B where the booth 20 is illuminated in the corporate color of the business operator B is regarded as an effect relating to the business operator B itself. Displaying a business or product corresponding to a purpose such as offering a loan or selling a financial product is regarded as an effect relating to the service of the business operator B.

As another example, in the case where the business operator B is a travel agency and the service of the business operator B is suggesting a travel destination, an effect corresponding to the travel destination is regarded as an effect relating to the service of the business operator B.

As another example, in the case where the business operator B is a cosmetic business operator and the service of the business operator B is selling or dealing with inquiries about cosmetics, spraying a perfume suitable for the customer C who is using the booth 20 from an atomizer (not illustrated in drawings) in the booth 20 to the customer C is regarded as an effect relating to the service of the business operator B.

### Flowchart

Next, a flowchart of a process of the controller 70 to determine the type of usage will be described with reference to drawings. When the unlock button on the entry procedure screen illustrated in FIG. 7 is pressed on the user terminal 30, the controller 70 determines, based on the reservation information at the entry procedure stage illustrated in FIGS. 4 and 5, the type of usage.

Specifically, in step S10, the CPU 72A of the controller 70 acquires reservation information of the booth 20 from the user terminal 30. Then, the CPU 72A proceeds to step S20.

In step S20, the CPU 72A determines whether or not the reservation information acquired from the user terminal 30 contains business operator information.

In the case where a negative determination result “N” is obtained, the type of usage of the user U of the booth 20 is determined to be personal use, and the CPU 72A proceeds to step S30.

In step S30, the CPU 72A causes the booth controller 22G of the booth 20 to do preparation for personal use including instruction to the booth devices 22. The preparation for personal use includes acquisition of key information, allowing the individual user I to enter the booth 20, and causing the booth devices 22 to accept the user terminal 30 of the individual user I to control the booth 20. Furthermore, controlling the monitor 22C by the user terminal 30 includes connecting the user terminal 30 to the monitor 22C and causing the screen of the connected user terminal 30 to be displayed on the screen of the monitor 22C. Then, the CPU 72A ends the process.

In contrast, in the case where an affirmative determination result “Y” is obtained, the type of usage of the user U of the booth 20 is determined to be business use, and the CPU 72A proceeds to step S40.

In step S40, the CPU 72A causes the booth controller 22G of the booth 20 to do preparation for business use including instruction to the booth devices 22. The preparation for business use includes acquisition of key information and effect information and allowing the customer C to enter the booth 20. Then, the CPU 72A ends the process.

### Provision of Service

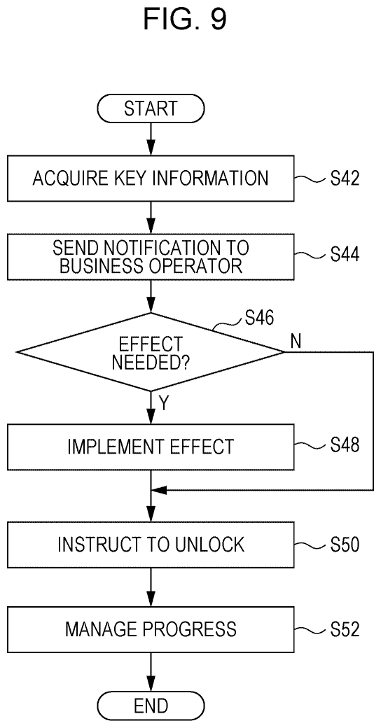

Next, a flowchart of a process of the controller 70 to provide a service including preparation for business use will be described with reference to FIG. 9.

In step S42, as the entry procedure stage, the CPU 72A of the controller 70 acquires from the reservation DB 50 key information and effect information included in the reservation information (see FIG. 5). Then, the CPU 72A proceeds to step S44.

In step S44, as the post-entry-procedure stage, the CPU 72A notifies the business operator B from which the customer C will receive provision of the service that the customer C has done the entry procedure for the booth 20. The notification is an example of informing. Specifically, information illustrated in FIGS. 10A and 10B is notified to the business operator B (including the person in charge P). Then, the CPU 72A proceeds to step S46.

In step S46, the CPU 72A determines, based on the effect information acquired from the reservation DB 50, whether or not an effect relating to the business operator B needs to be implemented to the booth 20.

In the case where an affirmative determination result “Y” is obtained, it is determined that an effect relating to the business operator B is necessary, and the CPU 72A proceeds to step S48.

In step S48, the CPU 72A causes the booth 20 to implement the effect relating to the business operator B.

For example, in the case where the monitor 22C is caused to implement the effect, the CPU 72A causes the monitor 22C to display information as the post-entry-procedure screen, which is illustrated in FIGS. 11A and 11C. The CPU 72A may cause the monitor 22C of the booth 20 to display the logo of the business operator B (see FIG. 11A) and an image of the person in charge P. Furthermore, in presenting display on the monitor 22C, the CPU 72A may display the face of the person in charge P instead of the logo of the business operator B when provision of the service by the person in charge P becomes ready. That is, when provision of the service by the person in charge P becomes ready, the display may be switched from the logo of the business operator B to information on the person in charge P. Displaying information by the monitor 22C may be one of aspects of the effect or one of aspects of provision of the service.

For example, in the case where the speaker 22D is caused to implement an effect, the CPU 72A causes the speaker 22D to output audio information specified in advance by the business operator B, for example, corporate sound, music associated with a media advertisement regarding the service of the business operator B, or the like.

For example, in the case where the light 22E is caused to implement an effect, the CPU 72A causes the light 22E to illuminate based on illumination information (including the corporate color) specified in advance by the business operator B.

Then, after implementing the effect, the CPU 72A proceeds to step S50.

In contrast, in the case where a negative determination result “N” is obtained in step S46, it is determined that an effect relating to the business operator B is not necessary, and the CPU 72A proceeds to step S50.

For example, in the case where an effect is not necessary, the CPU 72A causes the monitor 22C to display nothing.

In step S50, the CPU 72A causes the booth controller 22G to unlock the locking device (not illustrated in drawings) of the door 20A of the booth 20, based on the key information acquired from the reservation DB 50. Then, the CPU 72A proceeds to step S52.

In step S52, as the usage stage illustrated in FIG. 5, the CPU 72A carries out progress management. Specifically, the CPU 72A carries out progress management by causing the business operator terminal 40 (fixed terminal 40A) and the monitor 22C of the booth 20 to display the remaining time.

In this exemplary embodiment, an example in which the scheduled usage time is one hour will be described. In the case where the type of usage of the user U of the booth 20 is business use, the controller 70 or the booth controller 22G is able to allow the customer C to receive provision of the service from the business operator B without causing the booth devices 22 to accept the user terminal 30 of the customer C of the booth 20 to control the booth 20. That is, in this case, the customer C is able to receive provision of the service from the person in charge P of the business operator B in real time including sound through the monitor 22C, without using the user terminal 30.

As illustrated in FIGS. 12A and 13A, when five minutes have passed since the start of the scheduled usage time, the CPU 72A causes the fixed terminal 40A and the monitor 22C to display “55 minutes left” as the remaining time.

As illustrated in FIGS. 12B and 13B, when fifty minutes have passed since the start of the scheduled usage time, the CPU 72A causes the fixed terminal 40A and the monitor 22C to display “10 minutes left” as the remaining time.

Then, as illustrated in FIGS. 12C and 13C, when 55 minutes have passed since the start of the scheduled usage time, the CPU 72A causes the fixed terminal 40A and the monitor 22C to display “5 minutes left” as the remaining time.

Then, when the end button illustrated in FIG. 12C is pressed, the CPU 72A ends the process.

### Operation and Advantages

Operation and advantages of an exemplary embodiment will be described.

The controller 70 according to an exemplary embodiment implements, in a case where a business operator B provides a service to a booth 20 in which a plurality of business operators B are able to provide services, from outside the booth 20 via the internet line 60, an effect relating to the business operator B.

A program executed by the CPU 72A according to an exemplary embodiment causes a computer to execute a process including implementing, in a case where a business operator B provides a service to a booth 20 in which a plurality of business operators B are able to provide services, from outside the booth 20 via the internet line 60, an effect relating to the business operator B.

With the program executed by the controller 70 according to an exemplary embodiment or the CPU 72A according to an exemplary embodiment, the customer C is able to feel a connection between the booth 20 and the business operator B, compared to a configuration in which an effect irrelevant to a service provided from the business operator B to the customer C is implemented.

In the case where the type of usage of the user U of the booth 20 is personal use, the controller 70 according to an exemplary embodiment causes a booth device 22 installed at the booth 20 to accept the user terminal 30 of the individual user I of the booth 20 to control the booth 20.

With the configuration described above, the flexibility of usage of the booth 20 by the individual user I is increased compared to a configuration in which the booth 20 is controlled only by the controller 70.

The controller 70 according to an exemplary embodiment causes the monitor 22C installed at the booth 20 to accept the user terminal 30 of the individual user I of the booth 20 to control the monitor 22C.

The controller 70 according to an exemplary embodiment causes, as at least part of the effect, the monitor 22C installed at the booth 20 to display a logo associated with the business operator B.

The controller 70 according to an exemplary embodiment causes, as at least part of the effect, the speaker 22D installed at the booth 20 to output audio information associated with the business operator B.

The controller 70 according to an exemplary embodiment causes, as at least part of the effect, the light 22E installed at the booth 20 to illuminate in a color associated with the business operator B.

When an entry procedure for the booth 20 is completed, the controller 70 according to an exemplary embodiment notifies the business operator B that the entry procedure is completed.

In the case where a person who wishes to make a reservation reserves the booth 20, the controller 70 according to an exemplary embodiment changes, depending on the type of usage of the booth 20, display of an unavailable slot in which the booth 20 is not available to use.

In the case where a person who has reserved the booth 20 prior to the person who wishes to reserve the booth 20 is the business operator B, the controller 70 according to an exemplary embodiment changes, depending on the service of the person who has reserved the booth 20, display presented on the user terminal 30 and the business operator terminal 40 of the business operator B.

When the booth 20 is being used, the controller 70 according to an exemplary embodiment causes the monitor 22C of the booth 20 or the user terminal 30 of the customer C of the booth 20 to display information based on a scheduled usage time.

When the business operator B is providing the service to the customer C, the controller 70 according to an exemplary embodiment causes the business operator terminal 40 of the business operator B to display the information based on the scheduled usage time.

### Modifications

Exemplary embodiments of the present disclosure have been described above with reference to drawings. It is obvious to those of ordinary skilled in the art to which the present disclosure belongs that various modifications or applications can be conceived within the scope of the technical concept described in the claims, and it is understood that they are naturally included in the technical scope of the present disclosure.

In an exemplary embodiment described above, the booth system 10 includes the booth 20 including the booth controller 22G and the controller 70. However, the booth system 10 does not necessarily have the configuration described above. For example, the booth system 10 may include a customer controller (not illustrated in drawings) that supports provision of a service by the business operator B, in addition to the configuration described above. Furthermore, although the booth system 10 is managed by someone different from the business operator B in an exemplary embodiment described above, the booth system 10 is not necessarily managed by someone different from the business operator B. The booth system 10 may be managed by the business operator B. In this case, it is desirable that the booth 20 be not used for provision of a service by a competitor of the business operator B and be used for provision of a service by a business operator that does not compete against the business operator B.

Although the booth 20 is installed in a building in an exemplary embodiment described above, the booth 20 is not necessarily installed in the building. The booth 20 may be installed inside a moving thing such as a vehicle, a train, a ship, an aircraft, or the like. Furthermore, the booth 20 may be installed outside at least one store of the business operator B or outside the premises of the store. In this case, for example, a single business operator B may continuously provide a service in the booth 20.

Although, in reserving the booth 20 of the business operator B, application for provision of a service is made in a desired method by the customer C who wishes to receive provision of the service in an exemplary embodiment described above, application for provision of the service is not necessarily made as described above. For example, application for provision of a service may be made by selecting a service from the list of a plurality of services provided by a plurality of business operators B displayed on a screen (not illustrated in drawings) after logging into the booth system 10. In the case where this method is adopted, the list may contain description of services to be provided by the business operators B.

Although an effect is implemented before an unlocking instruction is issued, as illustrated in FIG. 9, in an exemplary embodiment described above, the effect is not necessarily implemented at this timing. An effect may be implemented at the same time as the issuance of the unlocking instruction or after the issuance of the unlocking instruction. Provision of a service by the business operator B includes preparation for business use.

As another example in which an effect is implemented before an unlocking instruction is issued, in the case where a slot before the scheduled usage time for the booth 20 by the user U is available, implementation of the effect may start a predetermined time before the scheduled usage time (for example, five minutes before the scheduled usage time). In this case, it is desirable that information about whether or not a slot before the scheduled usage time for the booth 20 by the user U is available be included in reservation information.

As another example, in the case where a slot before the scheduled usage time for the booth 20 by the user U is available, as an effect, the logo of the business operator B may be displayed on the monitor 22C of the booth 20. Then, when the business operator B (including the person in charge P) becomes ready, an image of the face of the person in charge P may be displayed on the monitor 22C. Effects may be implemented step by step as described above.

As another example, in the case where a slot before the scheduled usage time for the booth 20 by the user U is available, as an effect, an image of the face of the person in charge P may be displayed on the monitor 22C of the booth 20.

As another example, in the case where a slot before the scheduled usage time for the booth 20 by the user U is available, when the user terminal 30 of the user U of the booth 20 is detected, implementation of an effect may start. In this case, the user terminal 30 is detected using short-range wireless communication such as Bluetooth (registered trademark) and location information. Furthermore, as another modification of this case, when the scheduled usage time for the user U starts, an effect may start.

Although examples of the entry procedure include a case where the current location of the user terminal 30 is within the predetermined range from the reserved booth 20 and the unlock button of the user terminal 30 is pressed, as described below, in an exemplary embodiment described above, the entry procedure is not limited to this case.

For example, in the case where one or two or more of events (i) to (iv) described below occur after the unlock button is pressed, it may be considered that the entry procedure is completed:
(i) a signal indicating unlocking or locking is output from the locking device (not illustrated in drawings) at the door 20A of the booth 20;
(ii) a signal regarding opening/closing is output from an opening/closing sensor (not illustrated in drawings) at the door 20A of the booth 20;
(iii) a signal indicating that a human is detected is output from a human sensor (not illustrated in drawings) inside the booth 20; and
(iv) the lock button is pressed on the entry procedure screen (see FIG. 7) of the user terminal 30.

Although, during provision of a service, the CPU 72A of the controller 70 displays the remaining time on the business operator terminal 40 (fixed terminal 40A) and the monitor 22C of the booth 20 in an exemplary embodiment described above, the remaining timing is not necessarily displayed as described above. For example, the CPU 72A may display the remaining time on only one of the business operator terminal 40 (fixed terminal 40A) and the monitor 22C of the booth 20. In the case where the remaining time is displayed only on the business operator terminal 40, the customer C is able to concentrate on receiving provision of the service. On the other hand, in the case where the remaining time is displayed only on the user terminal 30, the person in charge P of the business operator B is not bothered by display of the remaining time.

Although the controller 70 restricts control of the booth devices 22 in the case where the type of usage is business use, compared to the case where the type of usage is personal use in an exemplary embodiment described above, control of all the booth devices 22 is not necessarily restricted. For example, the controller 70 may cause the air-conditioning device 22F to accept the user terminal 30 to control the air-conditioning device 22F. In this case, the customer C who uses the booth 20 is able to adjust the comfort of the booth 20.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. Furthermore, a program according to an exemplary embodiment of the present application may be provided as a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising:
a processor configured to:
   in a case where a provider provides a service to a booth in which a plurality of providers that provide services are able to provide the services, from outside the booth via a network, implement an effect relating to the provider.
(((2)))

The information processing system according to (((1))), wherein the processor is configured to cause, as at least part of the effect, a display device provided at the booth to present a display associated with the provider.
(((3)))

The information processing system according to (((1))) or (((2))), wherein the processor is configured to cause, as at least part of the effect, an audio device provided at the booth to output sound associated with the provider.
(((4)))

The information processing system according to any one of (((1))) to (((3))), wherein the processor is configured to cause, as at least part of the effect, a lighting device provided at the booth to illuminate in a color associated with the provider.
(((5)))

The information processing system according to any one of (((1))) to (((4))), wherein the processor is configured to, when an entry procedure for the booth is completed, inform the provider that the entry procedure is completed.
(((6)))

The information processing system according to any one of (((1))) to (((5))), wherein the processor is configured to, in a case where a type of usage of a user of the booth is personal use, cause an installed device provided at the booth to accept a terminal owned by the user of the booth to control the booth.
(((7)))

The information processing system according to any one of (((1))) to (((6))), wherein the processor is configured to cause a display device provided at the booth to accept the terminal owned by the user of the booth to control the display device.
(((8)))

The information processing system according to (((6))), wherein the processor is configured to, in a case where a person who wishes to make a reservation reserves the booth, change, depending on the type of usage of the user of the booth, display of an unavailable slot in which the booth is not available to use.
(((9)))

The information processing system according to (((8))), wherein the processor is configured to, in a case where a person who has reserved the booth prior to the person who wishes to reserve the booth is the provider, change, depending on the service of the person who has reserved the booth, display presented on a display device of a terminal owned by the person who wishes to reserve the booth.
(((10)))

The information processing system according to any one of (((1))) to (((9))), wherein the processor is configured to, when the booth is being used, cause a display device provided at the booth or a display device of a terminal owned by a user of the booth to display information based on a scheduled usage time.
(((11)))

The information processing system according to (((10))), wherein the processor is configured to, when the provider is providing the service to the user of the booth, cause a display device of a terminal of the provider to display the information based on the scheduled usage time.
(((12)))

The information processing system according to any one of (((1))) to (((11))), wherein the processor is configured to, in a case where an available slot before a scheduled usage time in which a user of the booth is to use the booth is available, start to implement the effect a predetermined time before the scheduled usage time.
(((13)))

The information processing system according to (((12))), wherein the processor is configured to:
cause, as the effect, a display device of the booth to display a logo of the provider; and
when the provider becomes ready to provide the service, cause the display device to display a person in charge of the provider.
(((14)))

The information processing system according to (((12))), wherein the processor is configured to include, as the effect, causing a display device of the booth to display a person in charge of the provider.
(((15)))

The information processing system according to any one of (((1))) to (((14))), wherein the processor is configured to, in a case where an available slot before a scheduled usage time in which a user of the booth is to use the booth is available, when a terminal owned by the user of the booth is detected, start to implement the effect.
(((16)))

A program causing a computer to execute a process for information processing, the process comprising:
in a case where a provider provides a service to a booth in which a plurality of providers that provide services are able to provide the services, from outside the booth via a network, implementing an effect relating to the provider.

What is claimed is:

1. An information processing system comprising:
a processor configured to:
in a case where a provider provides a service to a booth in which a plurality of providers that provide services are able to provide the services, from outside the booth via a network, implement an effect relating to the provider.

2. The information processing system according to claim 1, wherein the processor is configured to cause, as at least part of the effect, a display device provided at the booth to present a display associated with the provider.

3. The information processing system according to claim 1, wherein the processor is configured to cause, as at least part of the effect, an audio device provided at the booth to output sound associated with the provider.

4. The information processing system according to claim 1, wherein the processor is configured to cause, as at least part of the effect, a lighting device provided at the booth to illuminate in a color associated with the provider.

5. The information processing system according to claim 1, wherein the processor is configured to, when an entry procedure for the booth is completed, inform the provider that the entry procedure is completed.

6. The information processing system according to claim 1, wherein the processor is configured to, in a case where a type of usage of a user of the booth is personal use, cause an installed device provided at the booth to accept a terminal owned by the user of the booth to control the booth.

7. The information processing system according to claim 6, wherein the processor is configured to cause a display device provided at the booth to accept the terminal owned by the user of the booth to control the display device.

8. The information processing system according to claim 6, wherein the processor is configured to, in a case where a person who wishes to make a reservation reserves the booth, change, depending on the type of usage of the user of the booth, display of an unavailable slot in which the booth is not available to use.

9. The information processing system according to claim 8, wherein the processor is configured to, in a case where a person who has reserved the booth prior to the person who wishes to reserve the booth is the provider, change, depending on the service of the person who has reserved the booth, display presented on a display device of a terminal owned by the person who wishes to reserve the booth.

10. The information processing system according to claim 1, wherein the processor is configured to, when the booth is being used, cause a display device provided at the booth or a display device of a terminal owned by a user of the booth to display information based on a scheduled usage time.

11. The information processing system according to claim 10, wherein the processor is configured to, when the provider is providing the service to the user of the booth, cause a display device of a terminal of the provider to display the information based on the scheduled usage time.

12. The information processing system according to claim 1, wherein the processor is configured to, in a case where an available slot before a scheduled usage time in which a user of the booth is to use the booth is available, start to implement the effect a predetermined time before the scheduled usage time.

13. The information processing system according to claim 12, wherein the processor is configured to:
cause, as the effect, a display device of the booth to display a logo of the provider; and
when the provider becomes ready to provide the service, cause the display device to display information on a person in charge of the provider.

14. The information processing system according to claim 12, wherein the processor is configured to include, as the effect, causing a display device of the booth to display a person in charge of the provider.

15. The information processing system according to claim 1, wherein the processor is configured to, in a case where an available slot before a scheduled usage time in which a user of the booth is to use the booth is available, when a terminal owned by the user of the booth is detected, start to implement the effect.

16. A non-transitory computer readable medium storing a program causing a computer to execute a process for information processing, comprising:
in a case where a provider provides a service to a booth in which a plurality of providers that provide services are able to provide the services, from outside the booth via a network, implementing an effect relating to the provider.

17. An information processing system comprising:
means for,
in a case where a provider provides a service to a booth in which a plurality of providers that provide services are able to provide the services, from outside the booth via a network, implementing an effect relating to the provider.
